(19) United States
(12) Patent Application Publication
(10) Pub. No.: US 2008/0188129 A1
(43) Pub. Date: Aug. 7, 2008

(54) Connector in which defective electrical connection between a plurality of shell components is suppressed

(76) Inventors: Toshiyuki Moritake, Tokyo (JP); Tetsu Urano, Tokyo (JP)

Correspondence Address: COLLARD & ROE, P.C., 1077 NORTHERN BOULEVARD, ROSLYN, NY, 11576, US

(21) Appl. No.: 12/012,356

(22) Filed: Feb. 1, 2008

(30) Foreign Application Priority Data
Feb. 2, 2007 (JP) 2007-24049

(51) Int. Cl. H01R 13/648

(52) U.S. Cl. 439/609

(57) ABSTRACT

In a connector including a housing holding a contact, a shell covers the contact and the housing. The housing includes a protecting portion. The shell includes a first shell which includes a first contacting portion, and a second shell which includes a second contacting portion brought into contact with the first contacting portion in the protecting portion.

This application claims priority to prior Japanese patent application JP 2007-24049, filed on Feb. 2, 2007, the disclosure of which is incorporated herein in its entirety by reference.

### BACKGROUND OF THE INVENTION

This invention relates to a connector having a conductive shell disposed outside a connector body and, in particular, to a connector having a shell comprising a plurality of shell components.

A connector of the type is described in Japanese Unexamined Patent Application Publication (JP-A) No. H11-121094 and comprises a connector body connected to a cable and a shell disposed outside the connector body. The shell comprises a conductive upper shell fitted over the connector body from an upper side and a conductive lower shell fitted over the connector body from a lower side. The upper and the lower shells are electrically connected to each other when they are fitted over the connector body. In detail, the upper shell is provided with a leaf spring which is brought into contact with a side surface of the lower shell so that the upper and the lower shells are combined into an electrically integral structure.

### SUMMARY OF THE INVENTION

However, the above-mentioned leaf spring may be subjected to undesired deformation under external force during assembling of the connector, during manufacture of the shell, and so on. In that event, mechanical contact of the leaf spring is unstable so that electrical connection between the upper and the lower shells may become defective.

It is therefore an exemplary object of this invention to provide a connector in which defective electrical connection between a plurality of shell components is suppressed.

Other objects of the present invention will become clear as the description proceeds.

According to an exemplary aspect of the present invention, there is provided a connector comprising a contact, a housing holding the contact, and a shell covering the contact and the housing, wherein the housing includes a protecting portion, and wherein the shell comprises a first shell which includes a first contacting portion and a second shell which includes a second contacting portion brought into contact with the first contacting portion in the protecting portion.

### BRIEF DESCRIPTION OF THE DRAWINGS

FIG. 1A is a perspective view of a relay connector as a connector according to a first exemplary embodiment of this invention, together with a plug connector and a receptacle connector;

FIG. 1B is an enlarged perspective view of the relay connector illustrated in FIG. 1A;

FIG. 1C is an enlarged view of only a characteristic part of the relay connector in FIG. 1B;

FIG. 1D is an enlarged sectional view taken along a line Id-Id in FIG. 1C;

FIG. 1E is an enlarged perspective view of only a characteristic part of a shell of the relay connector in FIG. 1B in a disassembled state;

FIG. 2 is an enlarged perspective view of only a characteristic part of a connector according to a second exemplary embodiment of this invention;

FIG. 3A is an enlarged perspective view of only a characteristic part of a first modification of the shell;

FIG. 3B is a side view corresponding to FIG. 3A;

FIG. 4A is an enlarged perspective view of only a characteristic part of a second modification of the shell;

FIG. 4B is a side view corresponding to FIG. 4A;

FIG. 5A is an enlarged perspective view of only a characteristic part of a third modification of the shell;

FIG. 5B is a side view corresponding to FIG. 5A;

FIG. 6A is an enlarged perspective view of only a characteristic part of a fourth modification of the shell; and

FIG. 6B is a side view corresponding to FIG. 6A.

### DESCRIPTION OF THE EXEMPLARY EMBODIMENTS

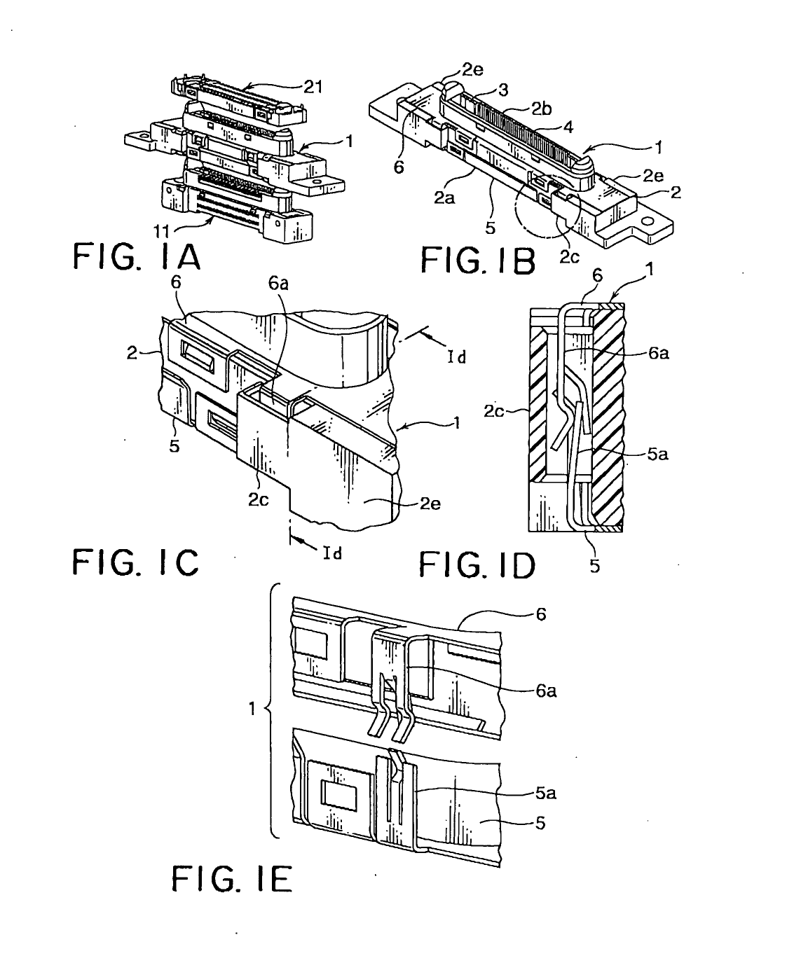

Referring to FIGS. 1A to 1E, description will be made of a connector according to a first exemplary embodiment of this invention.

The connector 1 is a so-called relay connector for connecting a plug connector 11 and a receptacle connector 21 to each other. As illustrated in FIG. 1A, the plug connector 11 is placed below the connector 1. The receptacle connector 21 is placed above the connector 1. The connector 1 is connected to each of the plug connector 11 and the receptacle connector 21.

As illustrated in FIG. 1B, the connector 1 comprises an insulating housing 2 having a center portion 2a. A conductive power supply contact 3 and a number of conductive signal contacts 4 are arranged on an upper surface of the center portion 2a and aligned in an array. The housing 2 is provided with a protruding portion 2b surrounding the power supply contact 3 and the signal contacts 4.

The center portion 2a of the housing 2 has a side surface and a lower surface which are covered with a conductive first shell 5 as a shell component. The upper surface of the center portion 2a and a peripheral surface of the protruding portion 2b are covered with a conductive second shell 6 as the other shell component. A plurality of protecting portions 2c are formed at four positions (in the figure, only the two positions on one side surface are illustrated). Each of the protecting portions 2c is provided with a flange portion 2e. A combination of the first and the second shells 5 and 6 may be called a shell.

The first shell 5 is connected to a plug shell (not shown) of the plug connector 11 to be electrically connected thereto. The second shell 6 is connected to a receptacle shell (not shown) of the receptacle connector 21 to be electrically connected thereto.

Referring to FIGS. 1C and 1D, each of the protecting portions 2c is of a tubular shape having a generally rectangular section. Each of the protecting portions 2c defines a hollow space therein which is extended and penetrated in a fitting direction along which the connector 1 is connected to each of the plug and the receptacle connectors 11 and 21 as a mating connector. The first and the second shells 5 and 6 include first and second contacting portions 5a and 6a, respectively, which are inserted in the hollow space that is defined by each protecting portions 2c. Thus, the first and the second contacting portions 5a and 6a are surrounded and protected by the protecting portions 2c.

As illustrated in FIG. 1D, the first contacting portion 5a of the first shell 5 and the second contacting portion 6a of the second shell 6 are brought into contact with each other in the protecting portion 2c.

Referring to FIG. 1E, the first contacting portion 5a of the first shell 5 and the second contacting portion 6a of the second shell 6 are faced to each other before they are brought into contact with each other. The first and the second contacting portions 5a and 6a are curved into a convex shape so that they are contacted with each other with a desired pressure and that forward, backward, leftward, and rightward movement beyond a predetermined range is inhibited. Furthermore, the first and the second contacting portions 5a and 6a have a trifurcated shape. The above-mentioned configuration will become clearer by other exemplary embodiments which will later be described.

In the structure described in connection with FIGS. 1A to 1E, even if the first and the second contacting portions 5a and 6a are deformed to some extent, for example, during manufacture of the first and the second shells 5 and 6, end portions of the first and the second contacting portions 5a and 6a are pressed by walls of the protecting portion 2c so that the first and the second contacting portions 5a and 6a are displaced towards each other to be brought into contact. Thus, electrical connection is reliably achieved.

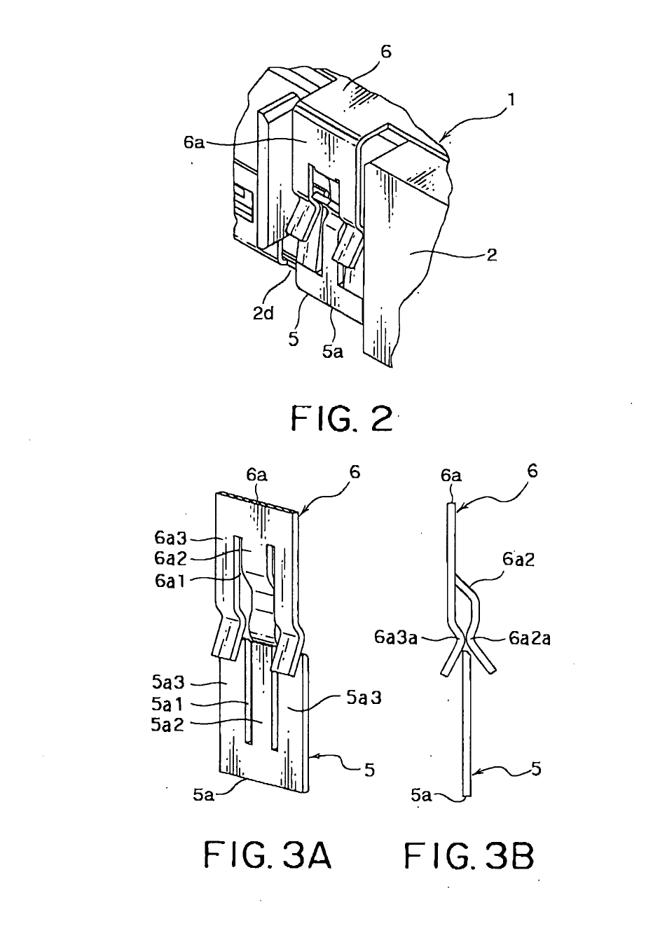

Referring to FIG. 2, description will be made of a connector according to a second exemplary embodiment of this invention. The connector according to the second exemplary embodiment of this invention is also a relay connector similar to the connector illustrated in FIGS. 1A to 1E and, therefore, depicted by the same reference numeral 1. Similar parts are designated by like reference numerals and description thereof may be omitted.

In the connector illustrated in FIGS. 1A to 1E, the protecting portion 2c is formed into a tubular shape having a generally rectangular section. On the other hand, in the connector illustrated in FIG. 2, a protecting portion 2d is formed as a groove having a generally U-shaped section. Both of the first and the second contacting portions 5a and 6a are disposed in the protecting portion 2d of a groove type. Therefore, the state of contact between the first and the second contacting portions 5a and 6a can be visually observed from a front side.

With the structure described in connection with FIG. 2, even if the first and the second contacting portions 5a and 6a are deformed to some extent, for example, during manufacture of the first and the second shells 5 and 6, end portions of the first and the second contacting portions 5a and 6a are pressed to each other so that the first and the second contacting portions 5a and 6a are displaced towards each other to be brought into contact. Thus, electrical connection is reliably achieved.

Next referring to FIGS. 3A and 3B, a first modification of the shell will be described. Similar parts are designated by like reference numerals and description thereof will be omitted.

As illustrated in FIG. 3A, the first contacting portion 5a is formed as a rectangular flat plate as a whole. The first contacting portion 5a has two slits 5a1 cut from its upper end to form a center section 5a2 and a pair of side sections 5a3 on left and right sides. Similarly, the second contacting portion 6a has two slits 6a1 cut from its lower end to form a center section 6a2 and a pair of side sections 6a3 on left and right sides.

As illustrated in FIG. 3B, the center section 6a2 is extended at a position near its base in parallel to the flat plate, then inclined rearward, then extended in parallel to the flat plate, and curved forward into a convex shape to form a protruding portion 6a2a. Each side section 6a3 is curved rearward at a position near its end to form a protruding portion 6a3a.

Each of the center section 5a2 and the side sections 5a3 of the first contacting portion 5a and the center section 6a2 and the side sections 6a3 of the second contacting portion 6a is elastically deformable in forward and backward directions. When the center section 5a2 and the side sections 5a3 of the first contacting portion 5a are brought into contact with the center section 6a2 and the side sections 6a3 of the second contacting portion 6a withan appropriate pressure, respectively, the first and the second shells 5 and 6 are reliably connected electrically.

The shell illustrated in FIGS. 3A and 3B may be used as a shell of the connector described in connection with FIGS. 1A to 1E and also as a shell of the connector described in connection with FIG. 2.

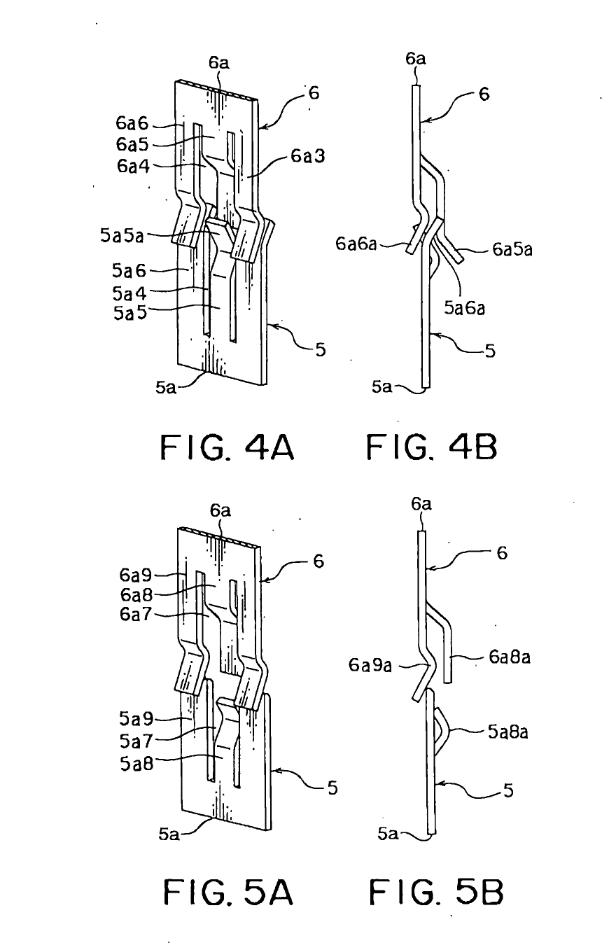

Referring to FIGS. 4A and 4B, a second modification of the shell will be described. Similar parts are designated by like reference numerals and description thereof may be omitted.

The first contacting portion 5a is provided with two slits 5a4 cut from its upper end to form a center section 5a5 and a pair of side sections 5a6 on left and right sides. The center section 5a5 has a curved portion formed at a position slightly spaced from its end and curved rearward into a convex shape. A part between the end and the curved portion forms an inclined flat portion 5a5a. Each side section 5a6 has a flat portion 5a6a formed near its end and inclined rearward.

The second contacting portion 6a is provided with two slits 6a4 cut from its lower end to form a center section 6a5 and a pair of side sections 6a6 on left and right sides. The center section 6a5 is at first extended at a position near its base in parallel to the flat plate, inclined rearward, then extended in parallel to the flat plate, and inclined rearward to form a flat portion 6a5a. Each side section 6a6 has a curved portion formed at a position slightly spaced from its end and curved rearward into a convex shape. A part between the end and the curved portion forms an inclined flat portion 6a6a.

When the inclined flat portions 5a5a and 5a6a of the first contacting portion 5a are brought into contact with the inclined flat portions 6a5a and 6a6a of the second contacting portion 6a, the first and the second contacting portions 5a and 6a are easily guided by each other.

The shell illustrated in FIGS. 4A and 4B may be used as a shell of the connector described in connection with FIGS. 1A to 1E and also as a shell of the connector described in connection with FIG. 2.

Referring to FIGS. 5A and 5B, a third modification of the shell will be described. Similar parts are designated by like reference numerals and description thereof will be omitted.

The first contacting portion 5a is provided with two slits 5a7 cut from its upper end to form a center section 5a8 and a pair of side sections 5a9 on left and right sides. The center section 5a8 has a protruding portion 5a8a formed at a position slightly spaced from its end and curved rearward into a convex shape. Each side section 5a9 has a flat shape. The protruding portion 5a8a has a peak point positioned below an end of each side section 5a9.

The second contacting portion 6a is provided with two slits 6a7 cut from its lower end to form a center section 6a8 and a pair of side sections 6a9 on left and right sides The center section 6a8 is inclined rearward from its intermediate portion and then extended in parallel to the flat plate to form a flat portion 6a8a. Each side section 6a9 is curved rearward into a convex shape in the vicinity of its end to form a protruding portion 6a9a. Each protruding portion 6a9a has a peak point positioned above an end of the center section 6a8.

Therefore, when the first and the second contacting portions 5a and 6a are brought into contact with each other, the timing when the peak points of the protruding portions 6a9a are brought into contact with the ends of the side sections 5a9 is different from the timing when the peak point of the protruding portion 5a8a is brought into contact with the end of the center section 6a8. Thus, there is a time lag between these timings. As a consequence, the first and the second shells 5 and 6 are connected with light force (zero insertion force).

The shell illustrated in FIGS. 5A and 5B may be used as a shell of the connector described in connection with FIGS. 1A to 1E and also as a shell of the connector described in connection with FIG. 2.

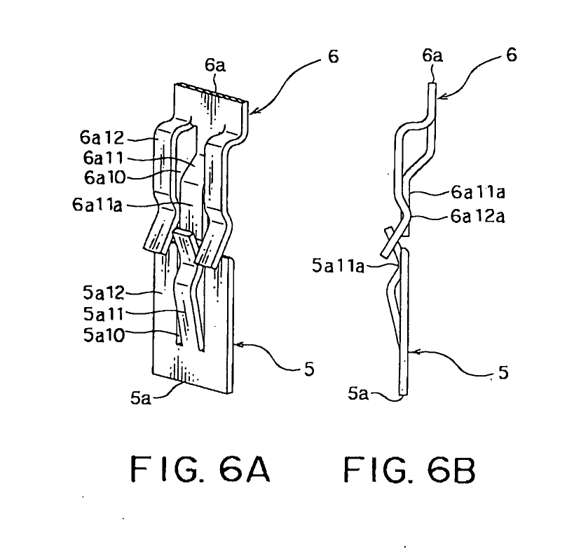

Referring to FIGS. 6A and 6B, a fourth modification of the shell will be described. Similar parts are designated by like reference numerals and description thereof may be omitted.

The first contacting portion 5a is provided with two slits 5a10 cut from its upper end to form a center section 5a11 and a pair of side sections 5a12 on left and right sides. The center section 5a11 is at first inclined forward from its base, then curved rearward in the middle to be inclined rearward, and then inclined forward to form a protruding portion 5a11a. Each side section 5a12 has a flat shape.

The second contacting portion 6a is provided with two slits 6a10 cut from its lower end to form a center section 6a11 and a pair of side sections 6a12 on left and right sides. The center section 6a11 is at first inclined forward at a position slightly spaced from its base and then extended in parallel to the flat plate to form a flat portion 6a11a. Each side section 6a12 is gently curved forward from its base in a generally perpendicular direction, then gently curved downward in a generally perpendicular direction to extend in parallel to the flat plate, then curved rearward, and inclined forward to form a protruding portion 6a12a.

A plane on which a peak point of the protruding portion 5a11a is brought into contact with the flat portion 6a11a is flush with a plane on which peak points of the protruding portions 6a12a are brought into contact with the side sections 5a12. Therefore, the first and the second contacting portions 5a and 6a can be contacted with each other on the same plane so that the contacting portions are reduced in thickness.

The shell illustrated in FIGS. 5A and 5B may be used as a shell of the connector described in connection with FIGS. 1A to 1E and also as a shell of the connector described in connection with FIG. 2.

In each of the exemplary embodiments and the modifications mentioned above, both of the first and the second contacting portions 5a and 6a are elastically deformable. However, the connector according to this invention may be modified in design so that only one of the first and the second contacting portions 5a and 6a is elastically deformable.

Hereinafter, various exemplary modes of embodying this invention will be given

1. A connector comprising a contact 4, a housing holding the contact 4, and a shell covering the contact 4 and the housing 2,
wherein the housing 2 includes a protecting portion 2c or 2d, and
wherein the shell comprises:
a first shell 5 which includes a first contacting portion 5a; and
a second shell 6 which includes a second contacting portion 6a brought into contact with the first contacting portion 5 in the protecting portion 2c or 2d.

2. The connector according to the first mode, wherein the protecting portion 2c is formed into a tubular shape having a generally rectangular section.

3. The connector according to the first mode, wherein the protecting portion 2d defines a groove therein having a generally U-shaped section

4. The connector according to the first mode, wherein at least one of the first and the second contacting portions 5a and 6a has elasticity.

5. The connector according to the first mode, wherein each of the first and the second contacting portions 5a and 6a is formed into a trifurcated shape.

6. The connector according to the first mode, wherein each of the first and the second contacting portions 5a and 6a includes a center section and a pair of side sections disposed on opposite sides of the center section.

7. The connector according to the sixth mode, wherein the second contacting portion 6a has a structure in which the center section is disposed nearer to the housing 2 than the side sections, and wherein the first contacting portion 5a is disposed in correspondence to a position between the side sections and the center section of the second contacting portion 6a.

8. The connector according to the seventh mode, wherein the center section of the first contacting portion 5a includes a part deformed towards the housing 2.

9. The connector according to the seventh mode, wherein the center section of the first contacting portion 5a has a flat shape.

10. The connector according to the seventh mode, wherein each of the side sections of at least one of the first and the second contacting portions 5a and 6a includes a part inclined so as to guide mutual contact between the first and the second contacting portions 5a and 6a.

11. The connector according to the sixth mode, wherein each of the first and the second contacting portions 5a and 6a has a structure in which the center section is substantially flush with the side sections, and wherein at least one of the center sections of the first and the second contacting portions 5a and 6a includes a part inclined so as to guide mutual contact between the first and the second contacting portions 5a and 6a.

12. The connector according to the sixth mode, wherein each of the first and the second contacting portions 5a and 6a has a structure in which the center section is substantially flush with the side sections, and wherein each of the side sections of at least one of the first and the second contacting portions 5a and 6a includes a part inclined so as to guide mutual contact between the first and the second contacting portions 5a and 6a.

Hereinafter, various exemplary effects of this invention will be described.

1. The housing has the protecting portion. The first and the second contacting portions of the first and the second shells are brought into contact with each other in the protecting portion. Therefore, both of the first and the second contacting portions are hardly subjected to unnecessary external force and can be prevented from undesired deformation.

2. Each of the first and the second contacting portions has a trifurcated shape. At least one of the first and the second contacting portions has elasticity. Therefore, the first and the second contacting portions can be reliably brought into contact at three positions.

3. The protecting portion is formed into a tubular shape having a generally rectangular section. Therefore, each of the first and the second contacting portions is protected with its four sides surrounded by the protecting portion.

4. The protecting portion may be formed as a groove having a generally U-shaped section. Therefore, the three sides of each of the first and the second contacting portions are protected and the state of contact therebetween can be visually observed on one side.

While the present invention has thus far been described in connection with the exemplary embodiments thereof, it will readily be possible for those skilled in the art to put this invention into practice in various other manners.

What is claimed is:

1. A connector comprising a contact, a housing holding the contact, and a shell covering the contact and the housing,
wherein the housing includes a protecting portion, and
wherein the shell comprises:
a first shell which includes a first contacting portion; and
a second shell which includes a second contacting portion brought into contact with the first contacting portion in the protecting portion.

2. The connector according to claim 1, wherein the protecting portion is formed into a tubular shape having a generally rectangular section.

3. The connector according to claim 1, wherein the protecting portion defines a groove therein having a generally U-shaped section.

4. The connector according to claim 1, wherein at least one of the first and the second contacting portions has elasticity.

5. The connector according to claim 1, wherein each of the first and the second contacting portions is formed into a trifurcated shape.

6. The connector according to claim 1, wherein each of the first and the second contacting portions includes a center section and a pair of side sections disposed on opposite sides of the center section.

7. The connector according to claim 6, wherein the second contacting portion has a structure in which the center section is disposed nearer to the housing than the side sections, and wherein the first contacting portion is disposed in correspondence to a position between the side sections and the center section of the second contacting portion.

8. The connector according to claim 7, wherein the center section of the first contacting portion includes a part deformed towards the housing.

9. The connector according to claim 7, wherein the center section of the first contacting portion has a flat shape.

10. The connector according to claim 7, wherein each of the side sections of at least one of the first and the second contacting portions includes a part inclined so as to guide mutual contact between the first and the second contacting portions.

11. The connector according to claim 6, wherein each of the first and the second contacting portions has a structure in which the center section is substantially flush with the side sections, and wherein at least one of the center sections of the first and the second contacting portions includes a part inclined so as to guide mutual contact between the first and the second contacting portions.

12. The connector according to claim 6, wherein each of the first and the second contacting portions has a structure in which the center section is substantially flush with the side sections, and wherein each of the side sections of at least one of the first and the second contacting portions includes a part inclined so as to guide mutual contact between the first and the second contacting portions.
